(19) United States
(12) Patent Application Publication
(10) Pub. No.: US 2009/0224551 A1
(43) Pub. Date: Sep. 10, 2009

(54) Oscillating Windmill

(76) Inventor: Johnnie Williams, Sand Springs, OK (US)

Correspondence Address: HEAD, JOHNSON & KACHIGIAN, 228 W 17TH PLACE, TULSA, OK, 74119, US

(21) Appl. No.: 12/104,136

(22) Filed: Apr. 16, 2008

Related U.S. Application Data
(63) Continuation-in-part of application No. 12/041,778, filed on Mar. 4, 2008.

(51) Int. Cl. F03D 9/00

(52) U.S. Cl. 290/55

(57) ABSTRACT

An oscillating windmill having the ability to generate clean electrical power by mechanically capturing the power of the wind. The oscillating windmill utilizes a rigid mast having a plurality of rotatable vanes. The lower section of the mast is fixed about an axis allowing the mast to oscillate in response to wind resistance upon the vanes. An actuating mechanism is in communication with the mast and the vanes to rotate the vanes about an axis in response to the oscillations of the mast. These oscillations of the mast are converted into usable energy using a power generating mechanism engagable with the mast.

### CROSS-REFERENCE TO RELATED APPLICATIONS

This application claims priority to and is a continuation-in-part of U.S. application Ser. No. 12/041,778, filed Mar. 4, 2008, which is incorporated herein by reference.

### 1. FIELD OF THE INVENTION

This invention relates generally to an oscillating windmill, and more particularly to an oscillating windmill which oscillates in response to wind resistance for capturing and extracting useable energy.

### 2. DESCRIPTION OF THE RELATED ART

Wind is a source of clean, renewable energy. Utilization of wind energy reserves the earth's fossil fuels (e.g., coal, natural gas and oil) and alleviates the additional environmental impacts associated with burning fossil fuels. Wind, as a clean, efficient and abundant, never-ending resource, generates clean energy using the most up-to-date technologies available. Today, wind energy is the fastest-growing renewable energy resource in the world. Wind currently only produces a small percentage of our nation's electricity; however during the past twenty (20) years, the cost of wind energy has dropped dramatically, making it competitive with other energy sources.

Wind is air in motion caused by the uneven heating of the earth's surface by the sun. The earth's surface is comprised of land and water, which absorb the sun's heat at different rates. During the day, the air above land heats up more readily than the air over water. The warm air over land heats, expands and rises, causing the heavier, cooler air to rush in and take its place, creating winds. At night, the winds are reversed because the air cools more rapidly over land than over water.

Since ancient times, people have harnessed the winds energy. Throughout history, societies have used wind to sail ships and have built windmills to grind wheat, corn and other grains, to pump water and to cut wood at sawmills. As late as the 1920's, Americans began using small windmills to generate electricity in rural areas without electric service. When power lines began to transport electricity to rural areas in the 1930's, local windmills were less frequently used.

The oil shortages of the 1970's changed the energy picture for the nation and the world by creating an interest in alternative energy sources, such as wind, solar, geothermal and other alternative energy sources. In the 1990's, a renewed interest in alternative energy sources came from a concern for the environment in response to scientific studies indicating potential changes to the global climate if the use of fossil fuels continued to increase. Wind is a clean, renewable fuel and wind farms produce no air or water pollution compared to refineries, because no fuel is burned. Growing concern about emissions from fossil fuels, increased government support, and higher costs for fossil fuels have helped wind power capacity in the United States grow substantially over the last ten (10) years.

Wind turbines typically capture the wind's energy using blades, which are mounted on a rotor, to generate electricity. When the wind blows, a pocket of low-pressure air forms on the downwind side of the blade; this low-pressure air pocket then pulls the blade toward it, resulting in lift and causing the rotor to turn. Since the force of the lift is much stronger than the force of the drag, the combination of lift and drag causes the rotor to spin like a propeller. The spinning rotor is connected to a generator to make electricity.

There are two main types of wind turbines used today based on the direction of the rotating shaft or axis: horizontal-axis wind turbines and vertical-axis wind turbines. The size of wind turbines varied from small turbines having a capacity of less than 100 kilowatts to large commercial sized turbines having a capacity of around five (5) megawatts. Larger turbines are often grouped together into wind farms that provide power to the electrical grid.

Most wind turbines being used today are the horizontal-axis wind turbines, typically having two or three airfoil blades. Horizontal-axis wind turbines generally harness winds at 100 feet (30 meters) or more above ground. Vertical-axis wind machines have blades that go from top to bottom, with the most common type being the Darrieus wind turbine. Vertical-axis wind turbines typically stand 100 feet tall and 50 feet wide. The Wind Amplified Rotor Platform (“WARP”) is a different type of wind system that does not use large blades. Each module of the WARP has a pair of small, high capacity turbines mounted to concave wind amplifier module channel surfaces. The concave surfaces channel wind toward the turbines, amplifying wind speeds.

It is an object of the oscillating windmill disclosed herein to provide a novel electricity generation system that can be powered by the oscillations in response to harnessed wind resistance.

It is also an object of the oscillating windmill to provide a novel electricity generation system that can be used to generate clean electrical power at a moderate cost.

It is another object of the oscillating windmill to provide a novel electricity generation system that utilizes rotatable vanes to harness wind energy and transmit this wind energy along an oscillating mast for conversion to a usable energy.

It is another object of the oscillating windmill to provide a novel electricity generation system that is economical to manufacture, market and maintain.

### SUMMARY OF THE INVENTION

In general, in a first aspect, the invention relates to an oscillating windmill having a plurality of vanes rotatably coupled to an upper section of a rigid, substantially upright mast. A lower section of the mast is fixed about an axis allowing the mast to oscillate in response to resistance harnessed by the vanes. An actuating mechanism is in communication with the mast and the vanes to rotate the vanes about an axis in response to the oscillations of the mast. A power generating mechanism is engagable with the mast for converting the oscillations of the mast into usable energy.

The vanes may be substantially horizontal and rotatably coupled to opposing sides of the mast. The vanes can also be collapsible to lay substantially parallel with the mast. The actuating mechanism may include an actuator that couples the mast to an actuating cable. The actuating cable can extend through an interior portion of the mast and may be coupled to the vanes. In this configuration, the oscillation of the mast triggers the actuator to actuate the actuating cable resulting in rotation of the vanes about an axis.

The lower section of the mast can further include a mast base and at least one gear wheel engagable with the power generating mechanism. The power generating mechanism can have a cogwheel engagable with the gear wheel and coupled to a drive axle, a transmission coupled to the drive axle, a flywheel coupled to the transmission, a gear box coupled to the flywheel, and a generator coupled to the gear box. In this configuration, the power generating mechanism coverts the oscillations of the mast into rotational energy, which in turn is converted into usable energy using the generator. The cogwheel may be two one-directional ratcheting drive hubs, wherein one of the hubs turns clockwise and the other hub turns counter-clockwise. The drive hubs may be placed side by side in parallel and engagable with the gear wheel.

The oscillating windmill may further comprise a platform having a mast support assembly. The mast support assembly may have a pair of mast support brackets, wherein each of the mast support brackets has a mast axle in communication with the lower section of the mast. A rotatable base may have a plurality of vertical support arms attached to the platform.

The oscillating windmill may also include a ballast assembly having at least one ballast element secured to a ballast cable. The ballast cable may be secured to a ballast drum. The ballast drum may be rotatably connected between the mast support brackets. A ballast gear may be in communication with the lower section of the mast and with the ballast drum. The oscillation of the mast causes the ballast gear to rotate the ballast drum. The rotation of the ballast drum winds and wraps the ballast cable resulting in restrictive movement of the ballast element. The restrictive movement of the ballast element of the ballast assembly aids in counter-oscillation of the mast. The ballast assembly may also include a plurality of ballast springs to further restrict the movement of the ballast element in response to the oscillations of the mast. In addition, the ballast assembly may include a ballast sheave for holding and directing the ballast cable.

The oscillating windmill may have a maintenance assembly with a maintenance motor powering a maintenance cogwheel. The maintenance cogwheel may be selectively engagable with the lower section of the mast to raise and lower the mast.

In general, in a second aspect, the invention relates to an oscillating windmill having a rigid mast with a plurality of rotatable vanes and at least one gear wheel. The gear wheel of the mast is fixed about an axis allowing the mast to oscillate in response to resistance upon the vanes. The oscillating windmill is also equipped with an actuating mechanism in communication with the mast and the vanes to rotate the vanes about an axis in response to the oscillations of the mast. A power generating mechanism is engagable with the gear wheel of the mast to convert the oscillations of the mast into usable energy. The oscillating windmill also includes a rotatable platform assembly supporting the mast and the power generating mechanism.

The vanes of the oscillating windmill may be substantially horizontal, rotatably coupled to opposing sides of the mast and collapsible to lay substantially parallel with the mast. The actuating mechanism may include an actuator that couples the mast to an actuating cable. The actuating cable may extend through an interior portion of the mast and coupled to the vanes. The oscillation of the mast triggers the actuator to actuate the actuating cable resulting in rotation of the vanes about an axis.

The power generating mechanism of the oscillating windmill may comprise a cogwheel engagable with the gear wheel and coupled to a drive axle, a transmission coupled to the drive axle, a flywheel coupled to the transmission, a gear box coupled to the flywheel, and a generator coupled to the gear box. In this configuration, the power generating mechanism coverts the oscillations of the mast into rotational energy, which in turn is converted into usable energy using the generator.

The rotatable platform assembly of the oscillating windmill may include a platform having a plurality of vertical support arms attached to a rotatable base. The platform may have a mast support assembly comprising a pair of mast support brackets, with each of the mast support brackets having a mast axle in communication with the gear wheel of the mast.

The oscillating windmill may also have a ballast assembly with at least one ballast element having a plurality of ballast springs and secured to a ballast cable. The ballast cable may be engaged with a ballast sheave and secured to a ballast drum. The ballast drum may be in communication with a ballast gear, which in communication with the gear wheel of the mast. The oscillation of the mast causes the ballast cable to wrap about the ballast drum resulting in restrictive movement of the ballast element against the ballast springs. The restrictive movement of the ballast element of the ballast assembly aids in counter-oscillation of the mast.

The oscillating windmill can also include a maintenance assembly having a maintenance motor powering a maintenance cogwheel. The maintenance cogwheel may be selectively engagable with the lower section of the mast to raise and lower the mast.

### BRIEF DESCRIPTION OF THE DRAWINGS

FIG. 1 is a perspective view of an example of an oscillating windmill in accordance with an illustrative embodiment of the oscillating windmill disclosed herein;

FIG. 2 is a side partial cutaway view of an example of lower assembly of an oscillating windmill in accordance with an illustrative embodiment of the oscillating windmill disclosed herein;

FIG. 3 is a side schematic view illustrating the vanes harnessing wind resistance causing the mast to oscillate;

FIG. 4 is a side schematic view illustrating the vanes releasing harnessed wind resistance allowing the mast to counter-oscillate;

FIG. 5 is an exploded view of area 5 of the vanes rotatably coupled to the mast to harness wind resistance causing the mast to oscillate as shown in FIG. 3;

FIG. 6 is an exploded view of area 6 of the vanes rotatably coupled to the mast to release harnessed wind resistance allowing the mast to counter-oscillate, as shown in FIG. 4;

FIG. 7 is a front perspective view along line 7-7 of the oscillating windmill shown in FIG. 3;

FIG. 7a is an exploded perspective view of area 7a of the oscillating windmill shown in FIG. 7;

FIG. 8 is a front perspective view along line 8-8 of the oscillating windmill shown in FIG. 4;

FIG. 8a is an exploded perspective view of area 8a of the oscillating windmill shown in FIG. 8;

FIG. 9 is an exploded, partial cutaway, perspective view of an example of the power generating mechanism and lower section of the mast of the oscillating windmill in accordance with an illustrative embodiment of the oscillating windmill disclosed herein;

FIG. 10 is a side schematic view illustrating the movement of the ballast assembly of the oscillating windmill in response to oscillations of the mast in accordance with an illustrative embodiment of the oscillating windmill disclosed herein;

FIG. 11 is another side schematic view illustrating the movement of the ballast assembly of the oscillating windmill in response to oscillations of the mast in accordance with an illustrative embodiment of the oscillating windmill disclosed herein;

FIG. 12 is another side schematic view illustrating the movement of the ballast assembly of the oscillating windmill in response to oscillations of the mast in accordance with an illustrative embodiment of the oscillating windmill disclosed herein;

FIG. 13 is another side schematic view illustrating the movement of the ballast assembly of the oscillating windmill in response to oscillations of the mast in accordance with an illustrative embodiment of the oscillating windmill disclosed herein;

FIG. 14 is another side schematic view illustrating the movement of the ballast assembly of the oscillating windmill in response to oscillations of the mast in accordance with an illustrative embodiment of the oscillating windmill disclosed herein;

FIG. 15 is a perspective view of an example of the oscillating windmill in the lowered position;

FIG. 16 is a perspective view of an example of the vanes of the oscillating windmill in an extended position; and

FIG. 17 is a perspective view of an example of the vanes of the oscillating windmill in a collapsed position.

Other advantages and features will be apparent from the following description, and from the claims.

### DETAILED DESCRIPTION OF THE PREFERRED EMBODIMENTS

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

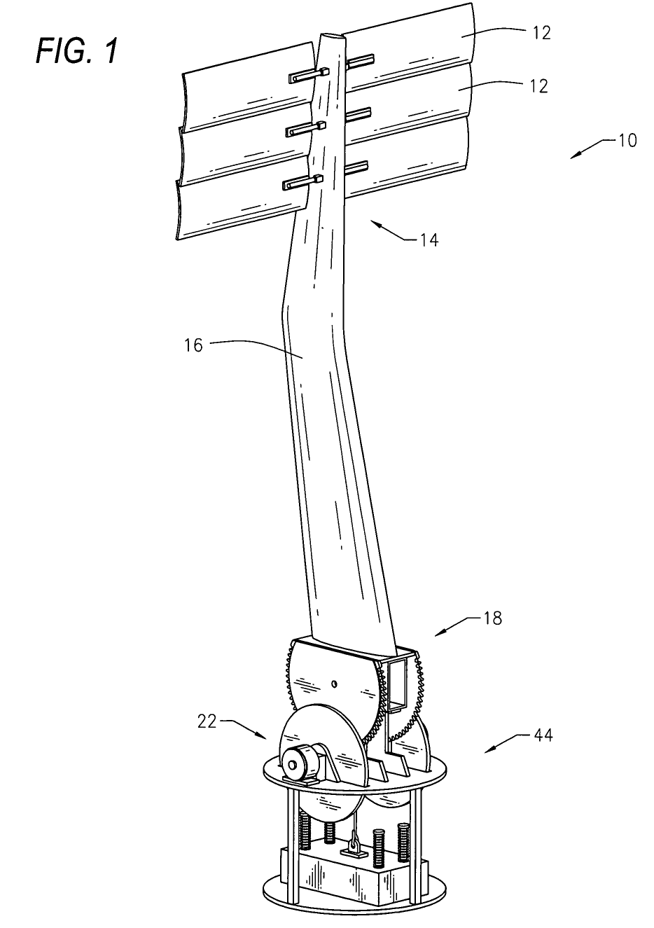

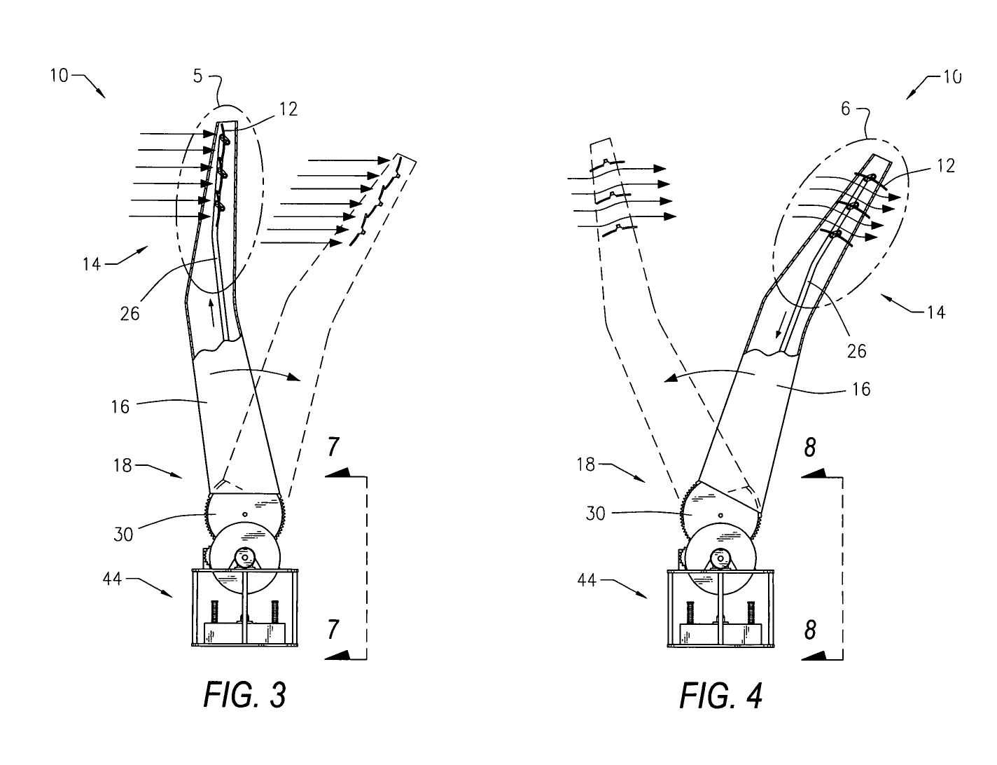

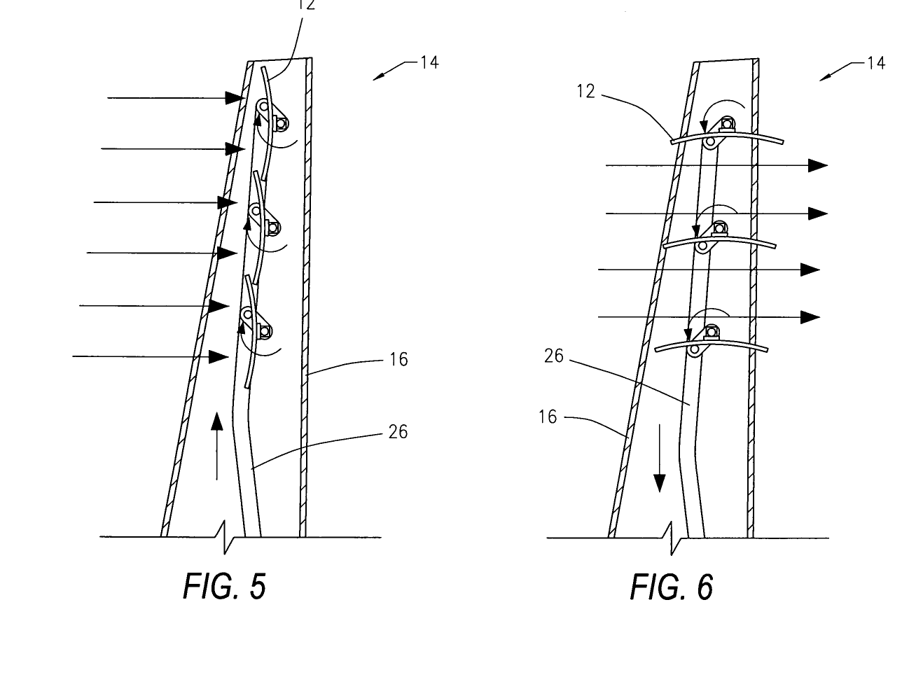

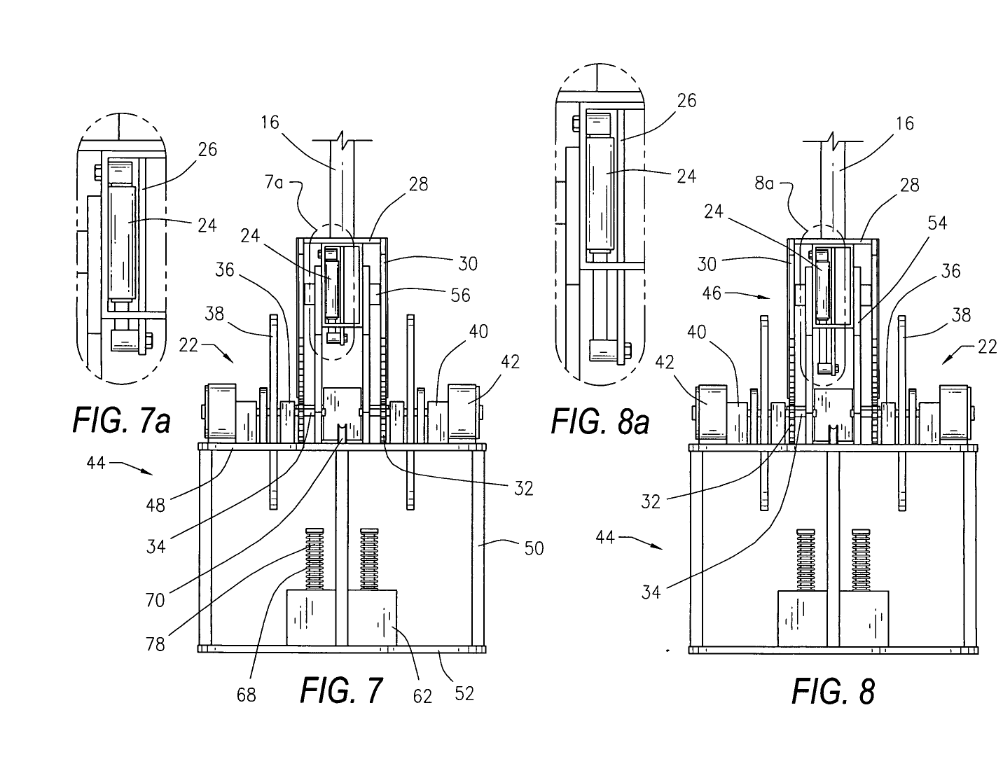

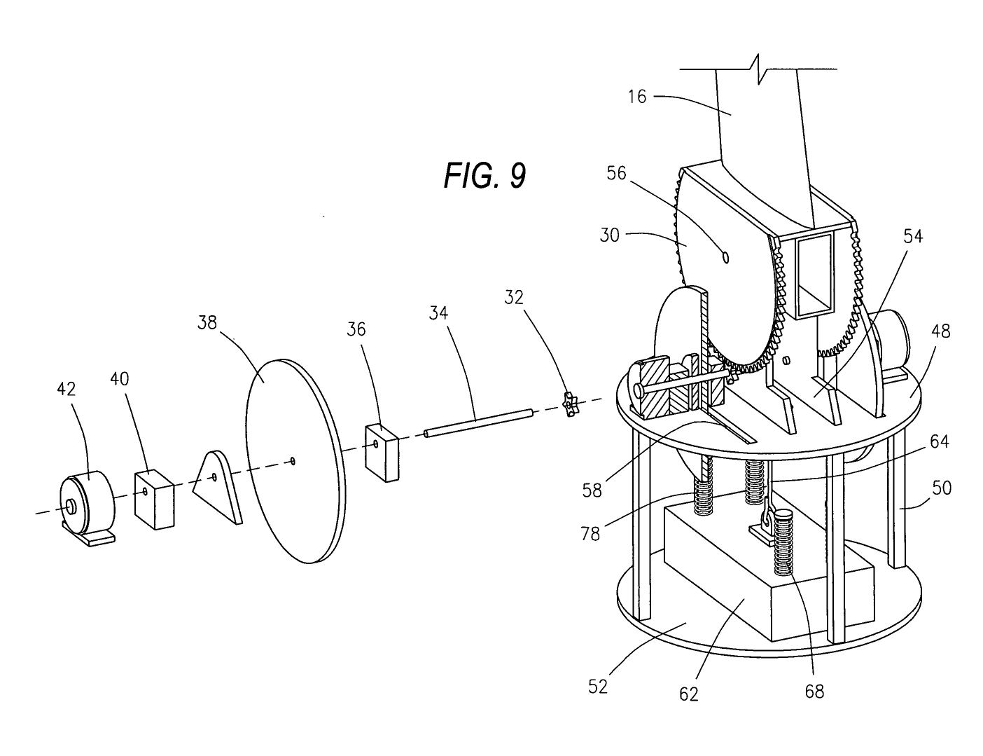

Referring to the figures of the drawings, wherein like numerals of reference designate like elements throughout the several views, and initially to FIG. 1, an oscillating windmill 10 having a plurality of vanes 12 rotatably coupled to an upper section 14 of a rigid, substantially upright mast 16. A lower section 18 of the mast 16 is fixed about an axis allowing the mast 16 to oscillate in response to wind resistance harnessed by the vanes 12, as illustrated in FIGS. 3 and 4. An actuating mechanism 20 is in communication with the mast 16 and the vanes 12 to rotate the vanes 12 about an axis in response to the oscillations of the mast 16, as shown in FIGS. 5 and 6. A power generating mechanism 22 is engagable with the mast 16 for converting the oscillations of the mast 16 into usable energy.

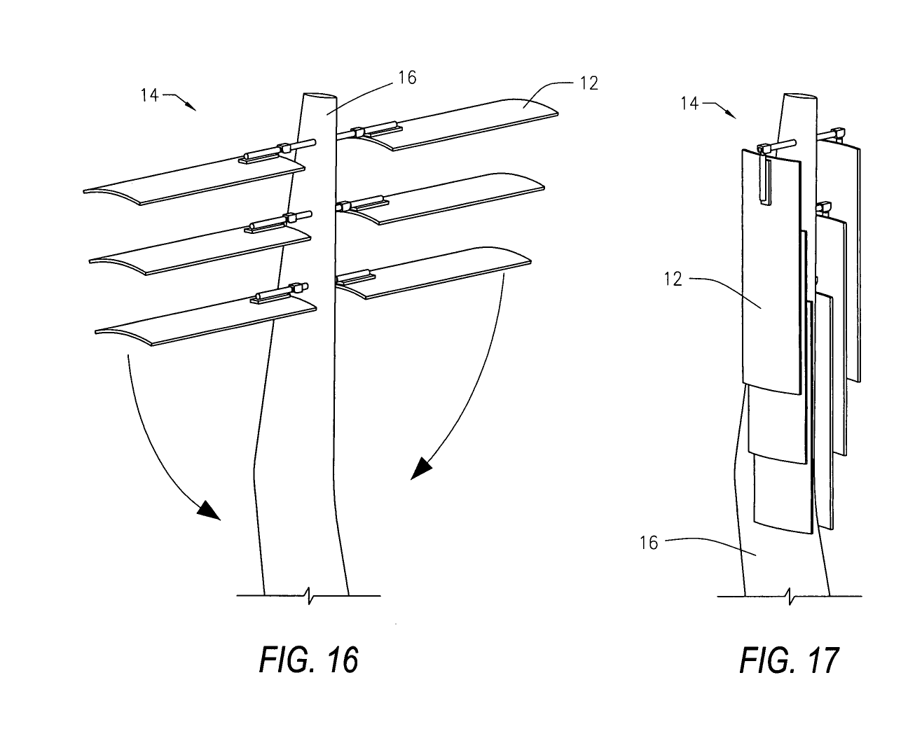

The vanes 12 may be substantially horizontal and rotatably coupled to opposing sides of the mast 16. The vanes 12 can also be collapsible to lay substantially parallel with the mast 16, as shown in FIGS. 16 and 17. The actuating mechanism 20 may include an actuator or piston 24 that couples the mast 16 to an actuating cable 26. The actuating cable 26 extends through an interior portion of the mast 16 and may be coupled to the vanes 12. In this configuration, the oscillation of the mast 16 triggers the actuator 24 to actuate the actuating cable 26 resulting in rotation of the vanes 12 about an axis, as shown in FIGS. 3 through 6. The triggering of the actuator 24 may be controlled using a sensor, solenoid or other known device that causes the actuator 24 to actuating of the actuating cable 26 at a predetermined angle of oscillation. As shown in FIGS. 3 through 6, the vanes 12 harness wind resistance causing the mast 16 to oscillate, and upon a predetermined angle of oscillation, the actuating mechanism 20 rotates the vanes 12, releasing the harnessed wind energy and allowing the mast 16 to counter-oscillate.

The lower section 14 of the mast 16 can further include a mast base 28 and at least one gear wheel 30 engagable with the power generating mechanism 22. The power generating mechanism 22 may include a cogwheel 32 engagable with the gear wheel 30 and coupled to a drive axle 34. The cogwheel 32 may be a one-directional, ratcheting drive hub and sprocket. The cogwheel 32 may be two one-directional ratcheting drive hubs wherein one hub may turn clockwise and the other hub may turn counter-clockwise. The two cogwheel drive hubs 32 may be placed side by side in parallel and operated by the gear wheel 30 simultaneously. Utilizing two cogwheel drive hubs 32 may result in a more constant flow of power to the flywheel 38. As the mast 16 oscillates, the gear wheel 30 rotates back and forth; this motion of the gear wheel 30 is transmitted to the cogwheel 32. The cogwheel 32 is coupled to a drive axle 34, which is in turn coupled to a transmission 36. The oscillating energy of the mast 16 is converted to rotational energy using the gear wheel 30 and the cogwheel 32. The rotation of the cogwheel 32 causes the drive axle 34 to rotate and drive the transmission 36. The transmission 36 may be an automatic high torque transmission. The transmission 36 is coupled to a flywheel 38, and the rotational energy imparted upon the transmission 36 is transmitted to the flywheel 38, causing the flywheel 38 to rotate. The inertia of the flywheel 38 is then transmitted through a gear box 40 to a generator 42, thus converting the oscillations of the mast 16 into rotational energy, which is converted into usable energy using the generator 42.

Once the flywheel's 38 inertia reaches an optimum rotation range, the transmission 36 can shift automatically to help increase the flywheel's 38 revolutions per minute. When the flywheel 38 reaches an optimum RPM range, which is primarily dependent upon the wind speed, a clutch in the gear box 40 will engage to further increase the drive axle 34 rotational speed to the generator 42. Thus, a power curve will develop that can be measured and manipulated.

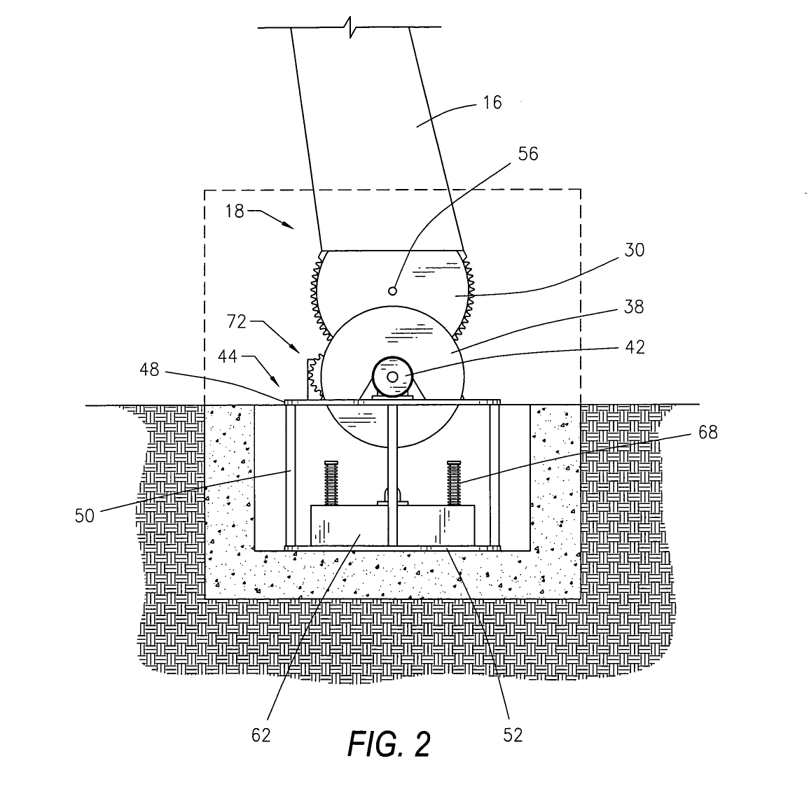

The oscillating windmill 10 may further comprise a rotatable platform assembly 44 having a mast support assembly 46. The rotatable platform assembly 44 of the oscillating windmill 10 may include a platform 48 having a plurality of vertical support arms 50 attached to a rotatable base 52. The mast support assembly 46 may have a pair of mast support brackets 54, with each of the mast support brackets 54 having a mast axle 56 in communication with the lower section 18 or gear wheel 30 of the mast 16. The platform 48 may also include a flywheel recess 58. The rotatable base 52 of the rotatable platform assembly 44 may include a plurality of bearings (not shown) to aid in rotating the oscillating windmill 10 in response to the direction of the prevailing winds. As shown in FIG. 2, the rotatable base 52 and support arms 50 may be placed below ground to decrease environmental wear and any noise associated with the operation of the oscillating windmill 10. It is further understood, the lower section 14 of the oscillating windmill 10 may be housed within a protective covering (not shown) to further reduce environmental wear and noise.

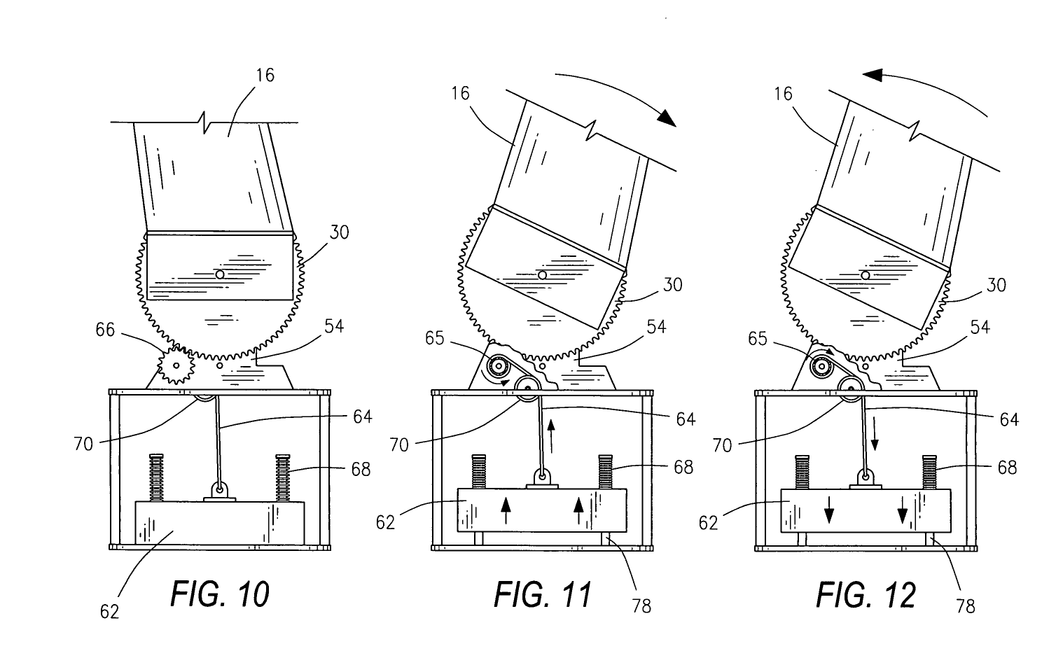

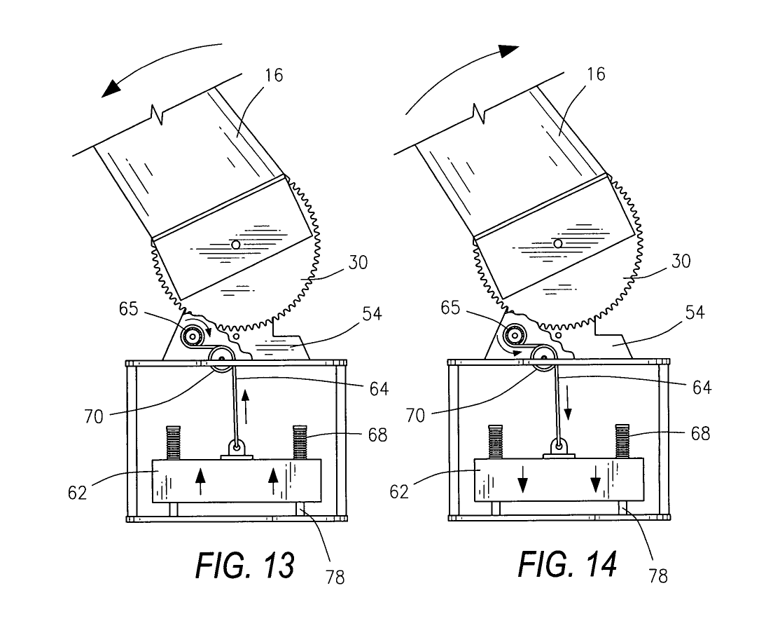

The oscillating windmill 10 may also include a ballast assembly 60 having at least one ballast element 62 secured to a ballast cable 64. The ballast cable 64 may be secured to a ballast drum 65. The ballast drum 65 may be rotatably connected between the mast support brackets 54 and rotatably connected to a ballast gear 66. The ballast gear 66 is in communication with the lower section 14 or gear wheel 30 of the mast 16. The oscillation of the mast 16 causes the ballast gear 66 to rotate the ballast drum 65, causing the ballast cable 64 to wrap about the ballast drum 65 resulting in restrictive movement of the ballast element 62. The restrictive movement of the ballast element 62 of the ballast assembly 60 aids in counter-oscillation of the mast 16, as shown in FIGS. 10 through 14. The ballast assembly 60 may also include a plurality of ballast springs 68 to further restrict the movement of the ballast element 62 in response to the oscillations of the mast 16. In addition, the ballast assembly may include a ballast sheave 70 rotatably attached to the platform 48 to hold and direct the ballast cable 64.

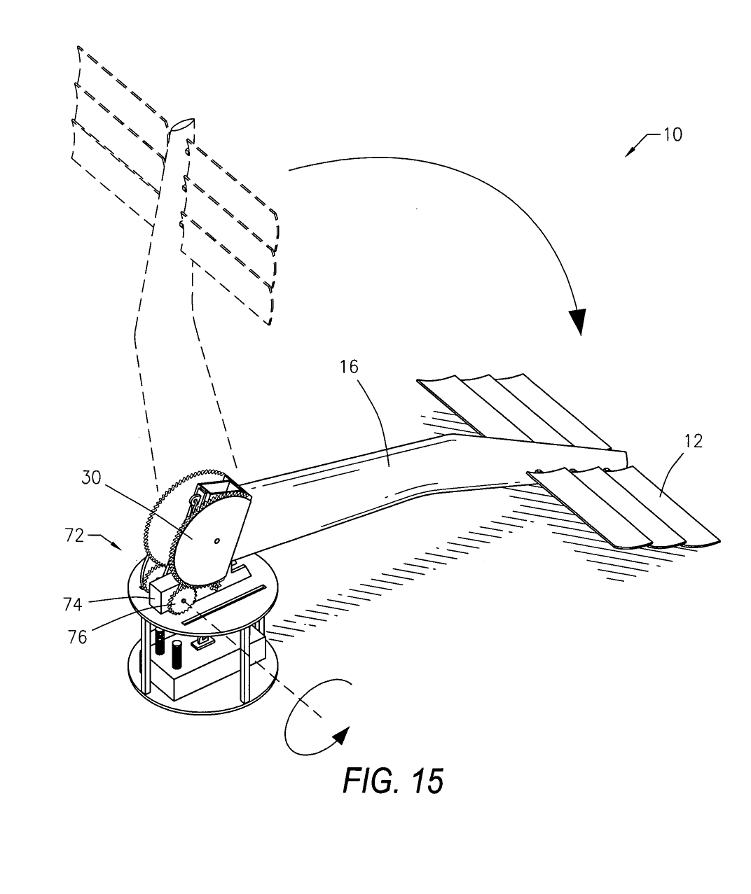

The oscillating windmill 10 may also have a maintenance assembly 72 with a maintenance motor 74 powering a maintenance cogwheel 76. As shown in FIG. 15, the maintenance cogwheel 76 may be selectively engagable with the lower section 14 or cog wheel 30 of the mast 16 to raise and lower the mast 16. The maintenance assembly 72 allows for the periodic maintenance the mast 16 and vanes 12.

The mast 16 may oscillate approximately fifteen (15) to twenty (20) degrees either side of vertical, giving the mast 16 an overall arc of approximately thirty (30) to forty (40) degrees. At the masts 16 forward most position, gravity and leverage is at its greatest on the mast 16 and vanes 12. When the vanes 12 close and the wind drives the mast 16 backward, the forward weight of the vanes 12 diminish as their weight translates downward into the mast 16 on its way toward vertical alignment. Approximately five (5) degrees before the vanes 12 reach vertical, the ballast cable 64 should engage the ballast element 62 within the rotatable platform assembly 44. When the vanes 12 reach approximately five (5) degrees past vertical, the ballast springs 68 on the ballast element 62 should begin to compress. As the vanes 12 pass vertical, their weight once again starts pushing the mast 16 backward. This extra load is absorbed by the ballast springs 68. At approximately fifteen (15) to twenty (20) degrees past vertical, the vanes 12 rotate open and the energy stored in the ballast assembly 60 drive the mast 16 forward. The ballast elements 68 slide up and down on guides 78, which should be long enough to accept this motion. Wind speed will determine the balance between the amount of energy available to turn the flywheel 38 and the amount of energy loaded into the ballast assembly 60. The ballast element 62 may be a set weight determined by how much force it takes to return the mast 16 to its forward position under relatively calm conditions. Higher wind speeds and their greater force will be absorbed by manipulating the downward pressure of the ballast springs 68.

Whereas, the devices and methods have been described in relation to the drawings and claims, it should be understood that other and further modifications, apart from those shown or suggested herein, may be made within the spirit and scope of this invention.

What is claimed is:

1. An oscillating windmill, comprising:
a plurality of vanes rotatably coupled to an upper section of a rigid, mast; a lower section of said mast being fixed about an axis allowing said mast to oscillate in response to resistance harnessed by said vanes;
an actuating mechanism in communication with said mast and said vanes to rotate said vanes about an axis in response to said oscillations of said mast; and
a power generating mechanism engagable with said mast for converting said oscillations of said mast into usable energy.

2. The oscillating windmill of claim 1 wherein said vanes are substantially horizontal and rotatably coupled to opposing sides of said mast.

3. The oscillating windmill of claim 1 wherein said actuating mechanism comprises an actuator that couples said mast to an actuating cable; said actuating cable extends through an interior portion of said mast and is coupled to said vanes; wherein said oscillation of said mast triggers said actuator to actuate said actuating cable resulting in rotation of said vanes about an axis.

4. The oscillating windmill of claim 1 wherein said lower section of said mast further comprises a mast base and at least one gear wheel engagable with said power generating mechanism.

5. The oscillating windmill of claim 4 wherein said power generating mechanism comprises a cogwheel engagable with said gear wheel and coupled to a drive axle, a transmission coupled to said drive axle, a flywheel coupled to said transmission, a gear box coupled to said flywheel, and a generator coupled to said gear box; wherein said power generating mechanism coverts said oscillations of said mast into rotational energy, which is converted into usable energy using said generator.

6. The oscillating windmill of claim 5 wherein said cogwheel comprises two one-directional ratcheting drive hubs; wherein one of said hubs turns clockwise and the other said hubs turns counter-clockwise; said drive hubs are be placed side by side in parallel and engagable with said gear wheel.

7. The oscillating windmill of claim 1 further comprising a ballast assembly having at least one ballast element secured to a ballast cable, said ballast cable secured to a ballast drum, said ballast drum rotatably connected to a ballast gear, which is in communication with said lower section of said mast; and wherein said oscillation of said mast causes said ballast gear to rotate said ballast drum causing ballast cable to wrap about said ballast drum resulting in restrictive movement of said ballast element; aiding in counter-oscillation of said mast.

8. The oscillating windmill of claim 7 wherein said ballast assembly includes a plurality of ballast springs to further restrict said movement of said ballast element in response to said oscillations of said mast.

9. The oscillating windmill of claim 7 wherein said ballast assembly includes a ballast sheave for holding and directing said ballast cable.

10. The oscillating windmill of claim 1 further comprises a platform having a mast support assembly; said mast support assembly having a pair of mast support brackets; each of said mast support brackets having a mast axle in communication with said lower section of said mast.

11. The oscillating windmill of claim 10 further comprising a rotatable base having a plurality of vertical support arms attached to said platform.

12. The oscillating windmill of claim 1 wherein said vanes are collapsible to lay substantially parallel with said mast.

13. The oscillating windmill of claim 1 further comprising a maintenance assembly having a maintenance motor powering a maintenance cogwheel; wherein said maintenance cogwheel is selectively engagable with said lower section of said mast to raise and lower said mast.

14. An oscillating windmill, comprising:
a rigid mast having a plurality of rotatable vanes and at least one gear wheel;
wherein gear wheel of said mast is fixed about an axis allowing said mast to oscillate in response to resistance upon said vanes;
an actuating mechanism in communication with said mast and said vanes to rotate said vanes about an axis in response to said oscillations of said mast;
a power generating mechanism engagable with said gear wheel of said mast for converting said oscillations of said mast into usable energy; and
a rotatable platform assembly supporting said mast and said power generating mechanism.

15. The oscillating windmill of claim 14 wherein said vanes are substantially horizontal and rotatably coupled to opposing sides of said mast and are collapsible to lay substantially parallel with said mast.

16. The oscillating windmill of claim 14 wherein said actuating mechanism comprises an actuator that couples said mast to an actuating cable; said actuating cable extends through an interior portion of said mast and is coupled to said vanes; wherein said oscillation of said mast triggers said actuator to actuate said actuating cable resulting in rotation of said vanes about an axis.

17. The oscillating windmill of claim 14 wherein said power generating mechanism comprises a cogwheel engagable with said gear wheel and coupled to a drive axle, a transmission coupled to said drive axle, a flywheel coupled to said transmission, a gear box coupled to said flywheel, and a generator coupled to said gear box; wherein said power generating mechanism coverts said oscillations of said mast into rotational energy, which is converted into usable energy using said generator.

18. The oscillating windmill of claim 14 further comprising a ballast assembly having at least one ballast element having a plurality of ballast springs and secured to a ballast cable, said ballast cable engaged with a ballast sheave and secured to a ballast drum, said ballast drum rotatably connected to a ballast gear in communication with said gear wheel of said mast; and wherein said oscillation of said mast causes said ballast gear to rotate said ballast drum causing said ballast cable to wrap about said ballast drum resulting in restrictive movement of said ballast element against said ballast springs; said restrictive movement of said ballast element of said ballast assembly aids in counter-oscillation of said mast.

19. The oscillating windmill of claim 14 wherein said rotatable platform assembly comprises a platform having a plurality of vertical support arms attached to a rotatable base; said platform having a mast support assembly comprising a pair of mast support brackets; each of said mast support brackets having a mast axle in communication with said gear wheel of said mast.

20. The oscillating windmill of claim 14 further comprising a maintenance assembly having a maintenance motor powering a maintenance cogwheel; wherein said maintenance cogwheel is selectively engagable with said lower section of said mast to raise and lower said mast.
